(19) United States
(12) Patent Application Publication
(10) Pub. No.: US 2008/0279344 A1
(43) Pub. Date: Nov. 13, 2008

(54) Emergency telephone system and method

(75) Inventors: Jonathan Echt, Chicago, IL (US); Yosef Klein, Skokie, IL (US); Zvie Liberman, Lincolnwood, IL (US); Samuel Shanes, Highland Park, IL (US); Clarence Wong, Chicago, IL (US); Sam Sangani, Hanover Park, IL (US); Saumil Makim, Algonquin, IL (US); Ashok Hirpara, Carol Stream, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: TALK-A-PHONE CO.

(21) Appl. No.: 12/079,056

(22) Filed: Mar. 24, 2008

Related U.S. Application Data
(60) Provisional application No. 60/919,462, filed on Mar. 22, 2007.

(51) Int. Cl. H04M 11/04

(52) U.S. Cl. 379/45

(57) ABSTRACT

An emergency telephone system has a dual mode, hybrid emergency telephone station connected with a central station through both a digital ethernet connection for digital VOIP communication and through a wire line for analog communication. Circuitry at the dual mode emergency station connects a user terminal with the digital ethernet connection and the wire line. A processor forming a part of the circuitry directs communication through the ethernet connection if operative and through the analog wire connection if the ethernet connection is inoperative.

### CROSS REFERENCE TO RELATED APPLICATIONS

This application is a continuation-in-part of Ser. No. 60/919,462.

### BACKGROUND OF THE INVENTION

Emergency telephone systems typically comprise a number of emergency telephone stations, each with a user terminal and located throughout the area to be served, e.g., a college or corporate campus, parking garage, or the like. The emergency telephone stations are connected with a central station where an attendant provides assistance for a user of the emergency telephone station in an emergency situation.

### BRIEF SUMMARY OF THE INVENTION

This invention provides enhancements for an emergency telephone system which improves system reliability and afford novel functions and features which make the system easier to us.

On feature is that the emergency telephone station has circuitry connecting the user terminal with both digital ethernet and analog wire line connections from the emergency telephone station to the central station and the circuitry includes a processor which directs communication between the user and the central station through the digital ethernet connection if the digital ethernet connection is operative and through the analog wire line if the digital ethernet connection is inoperative.

Another feature in an emergency telephone system having an emergency telephone station connected with a central station through an ethernet connection for communication using VₒIP protocol having discrete packets of digital audio signals, is the method of monitoring stats of the system which comprises exchanging status queries from the central station to the emergency telephone station and responses from the emergency telephone station to the central station during intervals between the discrete packets of digital audio signals.

A further feature of the emergency communication system is that the circuitry connecting the user terminal with the ethernet includes an ethernet converter or an ethernet switch and an IP compatible device, as a personal computer, is connected with the ethernet converter or ethernet switch.

Yet another feature of the system is that the circuitry connecting the user terminal with the ethernet includes a signal processor and that a visual display is connected with the signal processor displaying messages for the user at the emergency telephone station.

Yet a further feature is that the emergency telephone station has circuitry connecting the user terminal with either the ethernet connection or the wire line connection and includes a power source, and the emergency telephone station has a visual display to display an out-of-service message, the visual display being connected with the ethernet connection, the wire line connection, and the power source and is responsive to a loss of connection in the ethernet or wire line connections or an outage of the power source to display the out-of-service message, and a solar cell is connected with and powers the visual display.

Another feature is that the emergency terminal has both a handset and a loudspeaker for communication with the user and the processor in the emergency station circuitry is responsive to a command from the central station to direct an audio message from the central station either to the handset or the loudspeaker. This insures that the message will reach a user who does not remain at the user terminal.

A further feature is that the emergency telephone system has a primary central station and at least one secondary central station, and the circuitry which directs messages between the emergency telephone station and a central station includes a processor which directs calls to either the primary central station or the secondary central station, depending on the day and/or the time of day.

### BRIEF DESCRIPTION OF THE SEVERAL VIEWS OF THE DRAWINGS

FIG. 1 is a block diagram of an emergency telephone system;

FIG. 2 is a block diagram of a hybrid emergency telephone station;

FIG. 3 is a block diagram of an analog emergency telephone stations;

FIG. 4 is a block diagram of a VₒIP emergency telephone station; and

FIG. 5 is a diagrammatic illustration of an out-of-service display.

### DETAILED DESCRIPTION OF THE INVENTION

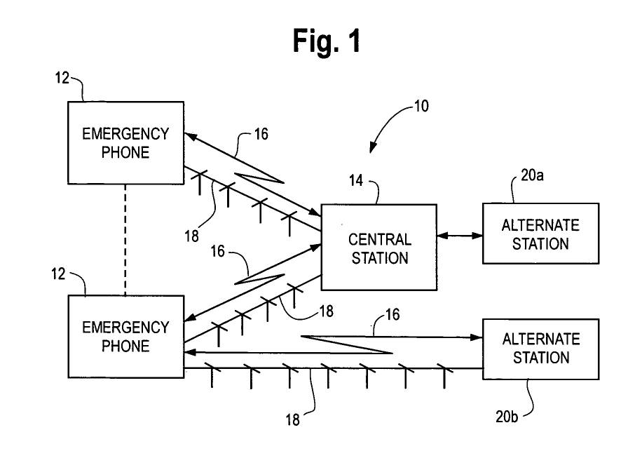

The principal components of an emergency telephone system 10 are illustrated in the block diagram, FIG. 1. Two emergency telephone stations 12 are connected with central station 14 through both an ethernet connection 16, e.g., a category 5 cable, and a wire line 18. In practice, an emergency telephone system will have many more emergency telephone stations located throughout the facility served.

The ethernet connection 16 provides two-way, digital communication using VₒIP protocol. The wire line connection 18 provides two-way analog communication. As will be explained in more detail below, digital communication through the ethernet connection is preferred. The system switches automatically to the analog wire line connection in the event of a failure of the digital communication.

Preferably, one or more alternate central stations 20 are provided to serve the system in the event of an equipment failure at central station 14 or during periods of little use as night time hours, weekends, and holidays. Alternate central station 20a is shown connected with the emergency phone stations 12 through a connection to central station 14. Alternatively, alternate central station 20b is connected directly with each of the emergency telephone stations 12 through an ethernet connection 16 and a wire line connection 18.

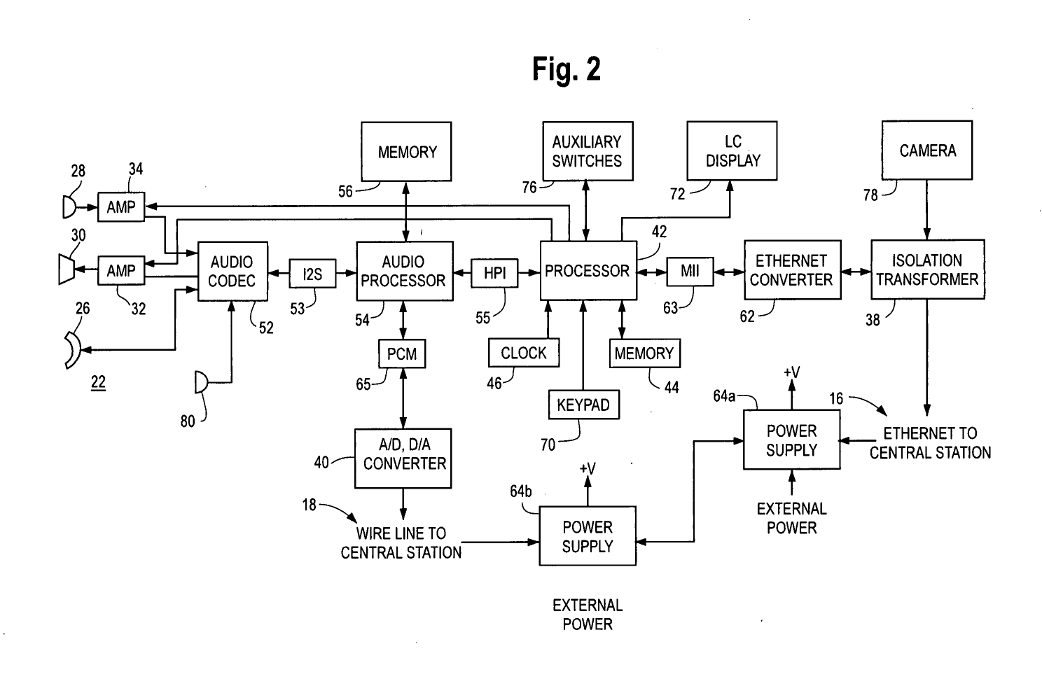

The emergency telephone station circuitry is shown in block form in FIG. 2. At user terminal 22, handset 26 enables a user to carry on two-way voice communication with an attendant at central station 14. Alternatively, microphone 28 and loudspeaker 30 may be used. Loudspeaker may also be used by the attendant at the central station to broadcast a message to anyone in the vicinity of the emergency station.

Ethernet connection 16 to the central station is connected with the emergency station circuitry through isolation transformer or integrated ethernet switch 38. Wire line 18 is connected with the emergency station circuitry through two-way analog to digital (A/D) and digital to analog (D/A) converter 40.

The emergency telephone is controlled by processor 42 with memory 44 which has programed instructions and also receives instructions from central station 14. Block 46 provides timing for processor 42 and other components of the emergency telephone station and indicates the time of day and date where that information is needed.

Audio CODEC 52 is connected with handset 26, microphone 28, and speaker 30, and through interface I2S 53 with the audio processor 54 to code and decode audio signals, converting analog signals to 16-bit digital signals and vice versa. Audio processor 54, with memory 56, is connected through Host Port Interface (HPI) 55 with processor 42.

Ethernet converter 62 is connected between isolation transformer 38 and, through Media Independent Interface (MII) 63, with processor 42. MII 63 transfers data using 4-bit nibbles in each direction to and from processor 42.

Power (+V) for the emergency telephone station circuitry is provided by power supplies 64a, 64b. The input power may be from an external source, e.g., 110V AC, or from power delivered over the ethernet 16 or the wire line 18. If the station is operating on power from the ethernet and the wire line and one of them fails, operation will continue with power from the other.

A user at the user terminal 22 initiates an emergency call with a voice message from handset 26 or microphone 28. The analog signal is coded at audio CODEC 52 and connected with audio processor 54. For ethernet communication, the audio processor signal is connected through processor 42 with ethernet converter 62 and isolation transformer 38 to ethernet 16 and thus to central station 14. A responsive voice message follows the reverse path.

If the ethernet connection is inoperative, processor 42 directs the emergency message from audio processor 54 through Pulse Code Modulation (PCM) interface 65, a capacitive isolation link, to converter 40 and to the wire line 18. Similarly, a responsive message follows the reverse path. Thus, the system continues to operate in the absence of the ethernet connection.

With the system operating over the ethernet connection, system status checks can be conducted while an emergency call is in progress. In accordance with the VₒIP protocol, audio signals are represented by packets of digital signals. Status queries and responses are transmitted over the ethernet connection during intervals between the packets of audio signals. Thus, the system can conduct status checks at any time without interrupting an emergency call. It is not necessary to delay either a status check or an emergency call because the system is already in use.

An ethernet protocol (IP) device can be added to the system by connection to ethernet switch 38 without requiring an external switch or an additional ethernet line. For example, an IP video camera 78 scanning the area of the emergency telephone station sends the video signal through ethernet switch 38 and ethernet converter 62 to the central station processor 42 and hence to the central station 14 over the ethernet connection or.

A liquid crystal (LC) display 72 at the user terminal 22 is connected with processor 42 and displays messages for a user of the emergency telephone system. The messages may, for example, indicate the status of an emergency call as —CALL PLACED— or a message from an attendant at the central station 14, for example, —HELP IS COMING—.

The attendant at the central station, through instructions sent to processor 42, controls amplifier 32 for loudspeaker 30 and amplifier 34 for microphone 28. If, for example, a warning message is to go to all in the vicinity of the emergency telephone station, the message is directed to loudspeaker 30 instead of handset 26, and sufficient volume is provided to cover the desired area adjacent the emergency station. Moreover, if a message is needed for all people near several or all of the emergency telephone stations in the system, it can be directed by the operator at the central station to the loudspeakers in multiple emergency telephone stations.

A microphone 80 senses ambient noise at user terminal 22 and through an amplifier in audio CODEC 52 adjusts the volume of the audio signal to handset 26.

The processor 42 in the emergency station, under control of clock 46 or a processor at central station 14 under control of an attendant or a memory directs an emergency call to an alternate central station 20, if appropriate.

Keypad 70 connected with processor 42 enables a user at the emergency telephone station to touch dial a telephone other than the central station in an appropriate situation; or a number entered on keypad 70 may, if desired, be displayed at LCD 72.

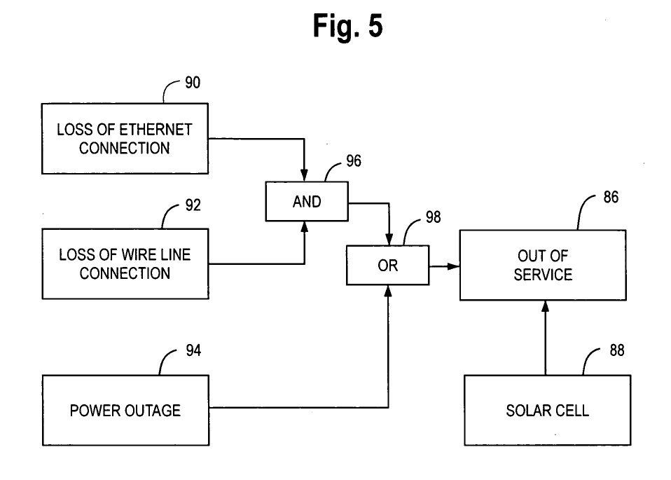

When an emergency telephone station 12 is inoperative, it is important that this information be communicated to a prospective user. A liquid crystal display (LCD) 86, FIG. 5, is powered by an independent power supply, as a solar cell 88. In the event of a loss of connection in both the ethernet 90 and wire line 92, or a power outage 94, the OUT OF SERVICE display is actuated through and gate 96 and or gate 98.

Processor 42 operates auxiliary switches 76 under control of the attendant at the central station to turn on or off lights, alarms or other auxiliary equipment at the emergency telephone station.

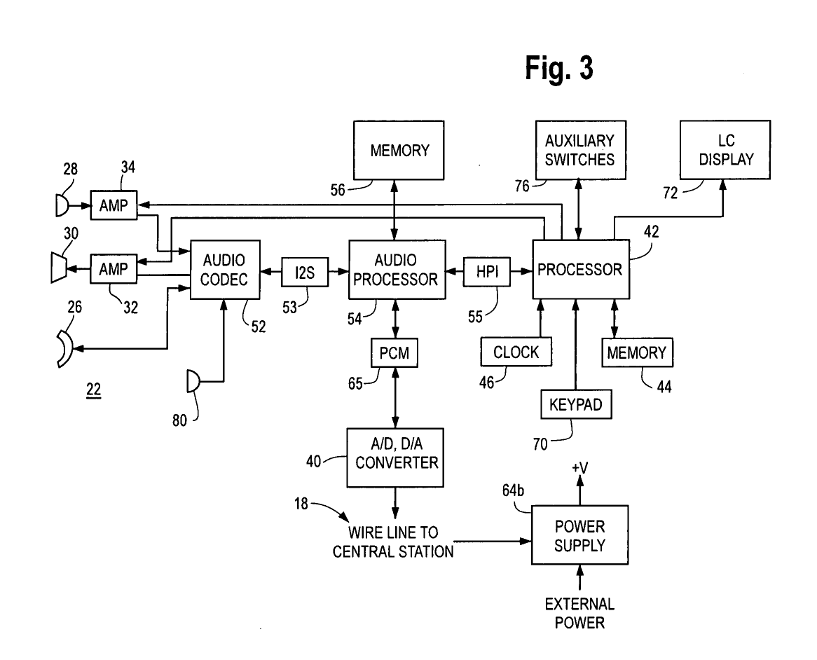

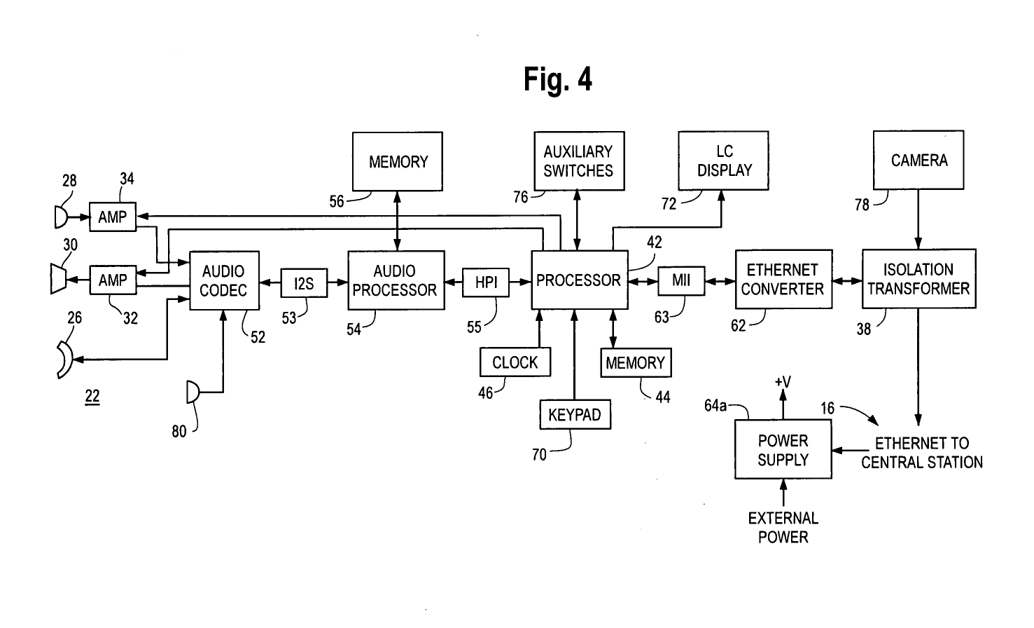

The circuitry components for the emergency station are typically mounted on a printed circuit board. The same board can be used in the manufacture of circuit boards for emergency telephone systems using only an ethernet connection or a wire line connection. FIG. 3 illustrates the circuit for wire line operation. FIG. 4 illustrates the circuit for ethernet operation. The saving in manufacturing cost makes the provision of multiple systems more economical.

1. In an emergency telephone system having a central station and a dual mode hybrid emergency telephone station connected with the central station through both a digital ethernet connection and an analog wire line connection, the emergency telephone station comprising:
a user terminal for receiving audio messages from the user and delivering audio messages to the user for communication of the user with the central station;
circuitry connecting the user terminal with the digital ethernet connection and with the analog wire line; and
a processor forming a part of said circuitry and directing communication between the user and the central station through the digital ethernet connection if the digital ethernet connection is operative and directing communication of the user with the central station through the analog wire line if the digital ethernet connection is inoperative.

2. In an emergency telephone system having an emergency telephone station connected with a central station through an ethernet connection for communication between the emergency telephone and the central station using VoIP protocol having discrete packets of digital audio signals, the method of monitoring status of the emergency telephone station which comprises:
exchanging status queries from the central station to the emergency telephone station and responses from the emergency telephones station to the central station during intervals between the discrete packets of digital audio signals.

3. In an emergency communication system having a central station and an emergency telephone station connected with the central station through the ethernet, the emergency telephone station comprising:
a user terminal at the emergency telephone station for receiving audio messages from a user and delivering audio messages to the user for communication between the user and the central station;
circuitry connecting the user terminal with the ethernet, said circuitry including an ethernet converter or ethernet switch; and
an IP compatible device connected with the ethernet converter or ethernet switch.

4. The emergency communication system of claim 3 in which said IP-compatible device is a personal computer.

5. In an emergency communication system having a central station and an emergency telephone station connected with the central station through the ethernet, the emergency telephone station comprising:
a user terminal at the emergency telephone station for receiving audio messages from a user and delivering audio messages to the user for communication between the user and the central station;
circuitry connecting the user terminal with the ethernet, said circuitry including a signal processor; and
a visual display connected with the signal processor displaying messages for the user at the emergency telephone station.

6. In an emergency communication system having a central station and an emergency telephone station connected with the central station through both an ethernet connection and a wire line connection, the emergency telephone station comprising:
a user terminal at the emergency telephone station for receiving audio messages from a user and delivering audio messages to the user for communication between the user and the central station;
circuitry connecting the user terminal with either the ethernet connection or the wire line connection, said circuitry including a power source;
a visual display to display an out of service message, said visual display being connected with the ethernet connection, the wire line connection and the power source to respond to a loss of connection in the ethernet and wire line connections or an outage of the power source to display the out of service message; and
a solar cell connected with and powering said visual display.

7. In an emergency communication system having a central station and an emergency telephone station connected with the central station through the ethernet, the emergency telephone station comprising:
a user terminal at the emergency telephone station for receiving audio messages from a user and delivering audio messages to the user for communication between the user and the central station;
circuitry connecting the user terminal with the ethernet, said circuitry including a signal processor; and
wherein the user terminal has a handset and a loudspeaker for communication with the user and the processor is responsive to a command from the central station to direct an audio message from the central station either to the handset or to the loudspeaker.

8. The system of claim 7 wherein the system has a plurality of emergency stations each with a loudspeaker and the processors of the emergency stations are responsive to commands from the central station to broadcast a message from selected loudspeakers.

9. The system of claim 8 wherein each emergency station has one or more loudspeakers and the processors of the emergency stations are responsive to commands from the central station to broadcast a message from selected loudspeakers at selected emergency stations.

10. An emergency communication system comprising:
an emergency telephone station;
a primary central station;
at least one alternate central station; and
circuitry for directing messages between an emergency telephone station and a central station and including a processor which directs calls from the emergency telephone station to either the primary central station or the alternate central station depending on the day and/or the time of day.
